(19) United States
(12) Patent Application Publication
(10) Pub. No.: US 2018/0183362 A1
(43) Pub. Date: Jun. 28, 2018

(54) CONTROL SYSTEM

(71) Applicant: Up First Construction Systems Pty Ltd, Greenfields, Western Australia (AU)

(72) Inventor: Philip Edward JENNER, Greenfields (AU)

(21) Appl. No.: 15/738,338

(22) PCT Filed: Jun. 24, 2016
(86) PCT No.: PCT/AU2016/000222

§ 371 Date: Dec. 20, 2017

(30) Foreign Application Priority Data
Jun. 26, 2015 (AU) 2015902496

(51) Int. Cl. H02P 5/685; B66F 3/46; H02P 7/20; G05B 19/042

(52) U.S. Cl. CPC H02P 5/685; B66F 3/46; E04B 1/3522; G05B 19/0428; H02P 7/20

(57) ABSTRACT

A control system for controlling the operation of a plurality of modular lifting units (12). The control system includes a power source (20) for providing power to each of the modular lifting units (12). A main control box connected between the power source (20) and the modular lifting units (12), comprises a mode switch (28) for switching the system between two control modes: a group mode, in which the plurality of modular lifting units (12) is controlled synchronously as a group; and, an individual mode, in which any one of the modular lifting units (12) is controlled independently of the other units. In group mode, synchronous movement of the modular lifting units is achieved by setting each unit to run at the same speed. The control system may also comprise one or more power extension control boxes (PECBs) (13) connected between an additional power source and a plurality of additional modular lifting units

### FIELD OF THE INVENTION

The present invention relates to a control system for controlling a plurality of modular lifters and relates particularly, although not exclusively, to such a control system for lifting a building structure using a plurality of lifting jacks.

### BACKGROUND TO THE INVENTION

In co-pending International Patent Application No PCT/AU2014/000224, the contents of which are incorporated herein by reference, a method of constructing a multi-storey building structure is described. In the method of PCT/AU2014/000224 an upper storey of the building structure is first constructed at ground level, then lifted up to the required height, after which a lower storey of the building structure is constructed underneath. This building method achieves significant cost savings and improvements in safety when constructing a building structure, as it eliminates the need for installing scaffolding and working at heights during construction of the upper storey.

Lifting of the upper storey of the building structure is accomplished by employing a plurality of lifting jacks, adapted to be attached to the upper storey of the building structure and then operating the jacks simultaneously to apply a lifting force to the upper storey. Each of the lifting jacks described in PCT/AU2014/000224 comprises a motor/gear box unit which is operatively connected to a leadscrew to transfer rotational movement to the leadscrew. A means for controlling the speed of rotation of the leadscrew, in the form of a variable speed drive, is also provided. This allows the speed of the motor/gear box unit to be varied in accordance with the speed required at the time of elevating the building structure. The jack may also include means for stopping the rotational movement of the motor/gear box unit in an emergency. A rotary encoder may be incorporated in the motor/gear box unit of the jack to allow the position of the output shaft of the motor/gear box unit to be monitored.

PCT/AU2014/000224 also briefly describes the provision of a programmable logic controller (PLC) for controlling and monitoring the entire process of elevating and lowering the building structure. The PLC is provided to coordinate the processes carried out by all control elements of the jack, such as the means for controlling the speed of rotation of the leadscrew, means for stopping the rotational movements of the motor/gear box unit, and the position of the leadscrew according to the rotary encoder. The PLC is programmed to permit each of the jacks to be controlled independently of the others. Independently controlling each jack avoids the need to provide communication via, for example, cables or lasers between a master jack and the other jacks, thus facilitating the process for elevating the upper storey of the building structure.

Whilst the control system described in PCT/AU2014/000224 worked satisfactorily in some situations, there were problems with its implementation in other applications. In particular, because of the very low gearing of the jack the motor ran at high speed whilst the jack moved a very small amount. To get useful feedback for such a very low geared jack, a servomechanism, (sometimes shortened to “servo”), was employed to provide error-sensing, negative feedback. The servo devices employed were all shaft mounted encoders with a synchronisation card connected to a motor Variable Speed Drive (VSD). However the very high sensitivity or resolution, (number of pulses per second) of the servo devices meant that even the smallest differences were magnified. The constant variation compounded, and each adjustment made was then over-compensated for by the control system. Because the sensitivity was so high, the variable speed drive (VSD) caused the motor in the jack to switch on and off at very short intervals, while the VSD's and synchronisation cards hunted for a consistent position signal. Under certain conditions the system became highly unstable.

The present invention was developed with a view to providing a more robust and reliable control system, capable of simultaneously controlling the operation of multiple lifting jacks during the elevation of a building structure. However it will be understood that the control system may also find useful application in other situations where multiple modular lifting units are required to be operated simultaneously to effect an elevating or lowering operation.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided a control system for controlling the operation of a plurality of modular lifting units, the control system comprising:
a plurality of modular lifting units;
a power source for providing power to each of the modular lifting units; and,
a main control box connected between the power source and the modular lifting units, the main control box comprising a mode switch for switching the system between two control modes: a group mode, in which the plurality of modular lifting units is controlled synchronously as a group; and, an individual mode, in which any one of the modular lifting units is controlled independently of the other units, and wherein, in group mode, synchronous movement of the modular lifting units is achieved by setting each unit to run at the same speed.

Preferably each modular lifting unit comprises a variable speed drive (VSD) for controlling the speed of an electric motor in the unit, and in group mode, synchronous movement of the modular lifting units is achieved by setting the VSD in each unit to run the motor at the same speed with no feedback from any part of the system.

Preferably the main control box further comprises a main controller, operatively coupled to the mode switch, for controlling the supply of electrical power to each of the modular lifting units. Typically the main control box also includes a main contactor which connects the power source to the modular lifting units via a three phase circuit breaker. Preferably the main control box also includes a power data logger for monitoring and recording electrical parameters for each of the modular lifting units. Preferably the main controller is a Programmable Logic Controller (PLC).

Preferably the control system further comprises a plurality of power extension control boxes (PECBs), when additional power sources are required and/or the number of modular lifting units exceeds a capacity of the main control box, each PECB being connected between an additional power source and a plurality of additional modular lifting units. Each of the PECBs is preferably under the control of the main control box.

According to another aspect of the present invention there is provided a control system for controlling the operation of a plurality of modular lifting units, the control system comprising:
a plurality of modular lifting units;
a power source for providing power to each of the modular lifting units;
a main control box connected between the power source and the modular lifting units, the main control box comprising:
   a mode switch for switching the system between two control modes: a group mode, in which the plurality of modular lifting units is controlled synchronously as a group; and, an individual mode, in which any one of the modular lifting units is controlled independently of the other units; and,
   a main controller operatively coupled to the mode switch for transmitting control signals to each of the modular lifting units, the main controller also receiving feedback signals from each of the modular lifting units wherein, in group mode, synchronous movement of the modular lifting units is achieved by the main controller using the feedback signals received from each of the modular lifting units to supply power to, monitor and control the speed of the modular lifting units.

Preferably each modular lifting unit (MLU) comprises an encoder for sensing a lifting position of the unit and providing a feedback signal to the main controller. Preferably the encoder is connected to an actuator of the MLU, where useful load position can be monitored. Typically the encoder generates a predetermined number of pulses, according to a prescribed resolution, for each 360° of rotation of a motor/gear box in the MLU. Typically, the encoder is used to measure a lift-carriage movement on a lifting jack, relative to a stationary reference point. Preferably the encoder is an absolute encoder or an incremental encoder.

Advantageously each modular lifting unit further comprises a MLU controller for processing data received from the encoder and preparing the feedback signals. Preferably the MLU controller controls the operation of the modular lifting unit with reference to an algorithm within the MLU controller for controlling the MLU and/or transmitting the feedback signals to the main controller. In one embodiment each modular lifting unit comprises a variable speed drive (VSD) for controlling the speed of an electric motor in the unit.

Preferably each modular lifting unit also includes a load cell in order to measure the weight of a structure to be lifted and to monitor any change in load for the purpose of adjusting position.

Preferably the main controller comprises a Programmable Logic Controller (PLC) for controlling the supply of electrical power to each of the modular lifting units. Typically the main control box also includes a main contactor which connects the power source to the modular lifting units via a three phase circuit breaker.

Preferably the control system further comprises a plurality of power extension control boxes (PECBs), when additional power sources are required and/or the number of modular lifting units exceeds a capacity of the main control box, each PECB being connected between an additional power source and a plurality of additional modular lifting units. Preferably each PECB comprises a slave controller, operatively coupled to the main controller, for controlling the supply of electrical power to each of the additional modular lifting units. Preferably the slave controller is a Programmable Logic Controller (PLC). Preferably each PECB also includes a power data logger for monitoring and recording electrical parameters for each of the additional modular lifting units.

Advantageously the main controller monitors the actual position of each modular lifting unit (MLU) and adjusts the lifting by sending instructions to the MLU controller in each MLU. This enables the control system to synchronise and control the actual position of each modular lifting unit via adjustments in speed.

Preferably the main control box also comprises a wireless transmitter/receiver for transmitting and receiving wireless signals to/from the modular lifting units. Preferably each modular lifting unit also comprises a wireless transmitter/receiver for receiving control signals and transmitting feedback signals wirelessly to the main controller. Preferably each PECB also comprises a wireless transmitter/receiver for transmitting and receiving wireless signals to/from the main control box.

According to a further aspect of the present invention there is provided a method of controlling the operation of a plurality of modular lifting units via a main control box and a plurality of power extension control boxes (PECBs), each PECB being connected to the main control box and between an additional power source and a plurality of additional modular lifting units (MLUs) respectively, the method comprising:
detecting the number of PECBs; and,
providing feedback signals from each of the PECBs to the main control box.

Preferably the power extension control boxes (PECBs) are connected between various power sources, such as on-site generators or on-site power boxes or other power sources and the additional modular lifting units. Each PECB is typically controlled by the main control box. Preferably the main control box switches a main contactor inside each PECB ON or OFF in order to energize or de-energize the MLUs connected to each PECB respectively.

Advantageously each PECB sends a feedback signal or a series of feedback signals to the main control box to indicate if the main contactor in each PECB is working.

Preferably each PECB includes a data logging device, which records various electrical parameters, such as total current drawn, voltage per operation, amount of electrical disconnections, three phase unbalance situations, amongst others, that are then sent to a main controller in the main control box for future analysis.

According to a still further aspect of the present invention there is provided a method of controlling the operation of a plurality of modular lifting units via a main control box connected between a power source and the modular lifting units, the method comprising the steps of:
detecting the number of modular lifting units connected to a control network;
providing power to each of the modular lifting units in accordance with the method;
selecting one of two control modes: a group mode, in which the plurality of modular lifting units is controlled synchronously as a group; and, an individual mode, in which any one of the modular lifting units is controlled independently of the other units; and,
transmitting control signals from the main controller to the modular lifting units wherein, in group mode, synchronous movement of the modular lifting units is achieved by using feedback signals received from each of the modular lifting units to supply power to, monitor and control the speed of the modular lifting units.

Preferably each modular lifting unit (MLU) comprises an encoder and the method comprises the further steps of: sensing a lifting position of the unit and providing a feedback signal to the main controller. Preferably the encoder is an absolute encoder, or an incremental encoder.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the control system, given by way of example only, with reference to the accompanying drawings, in which:

FIG. 1 is a functional block diagram of a first embodiment of a control system according to the present invention illustrating the control topology;

FIG. 2 is a functional block diagram of the control system of FIG. 1 illustrating the power topology;

FIG. 3 is a functional block diagram of a main control box in a second embodiment of a control system according to the present invention;

FIG. 3.1 is a functional block diagram of a power extension control box in the second embodiment of a control system according to the present invention;

FIG. 4 is functional block diagram of a modular lifting unit in the control system of FIG. 3;

FIG. 5 is a functional block diagram of a third embodiment of a control system according to the present invention illustrating the control topology;

FIG. 5.1 is a functional block diagram of the third embodiment of a control system illustrated in FIG. 5, including one or more power extension control boxes in the control topology;

FIG. 6 is a functional block diagram of the control system of FIG. 5 illustrating the power topology;

FIG. 7 is a functional block diagram of a main control box in the control system of FIG. 5;

FIG. 7.1 is a functional block diagram of a power extension control box in the control system of FIG. 5.1;

FIG. 8 is functional block diagram of a modular lifting unit in the control system of FIG. 5;

FIGS. 9, 9.1, 9.2 and 9.3 are a flowchart illustrating the steps implemented in the software programming for a main PLC in the control system of FIGS. 3 and 5;

FIG. 10 is a functional block diagram of an alternative topology for the third embodiment of a control system according to the present invention illustrating the power topology; and,

FIG. 11 is a functional block diagram of a main control box in the control system of FIG. 10.

### DETAILED DESCRIPTION OF PREFERRED EMBODIMENTS

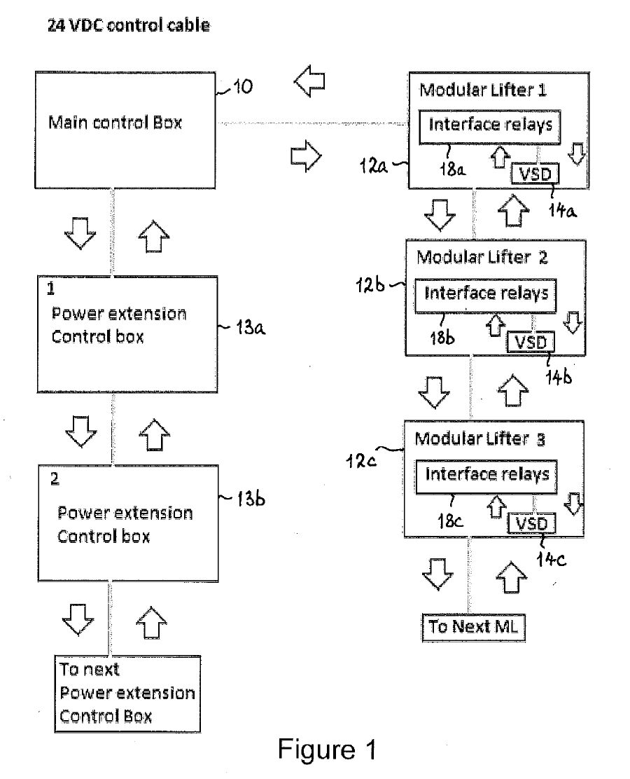

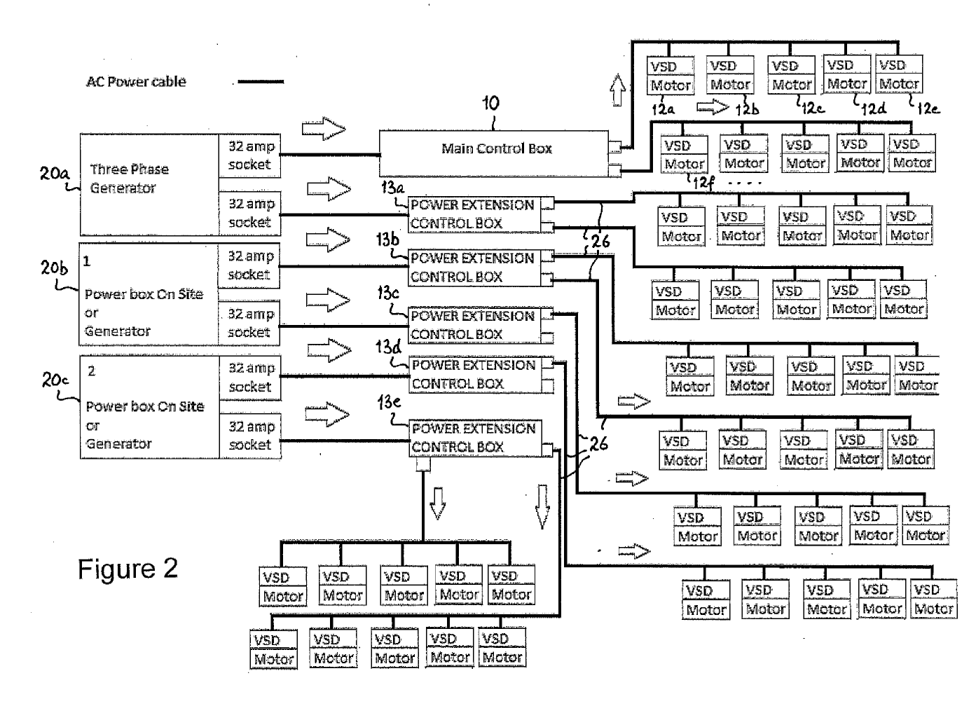

A first embodiment of a control system in accordance with the invention, for controlling a plurality of modular lifting units 12, is illustrated in FIGS. 1 and 2. The control system comprises a main control box 10 for controlling a plurality of modular lifting units (MLUs) 12 connected in a daisy chain configuration. Optionally, the control system also comprises a plurality of power extension control boxes 13 for distributing the electrical power to additional modular lifting units 12 when the number of MLUs exceeds the limit the main control box 10 can distribute electrical power to. Each modular lifting unit 12 could be a lifting jack similar to that described in PCT/AU2014/000224, and comprises a variable speed drive (VSD) 14 for controlling the speed of an electric motor/gear box 16 (not shown in FIGS. 1 and 2) in the unit. Each modular lifting unit 12 is also fitted with a 24 volt interface relay 18.

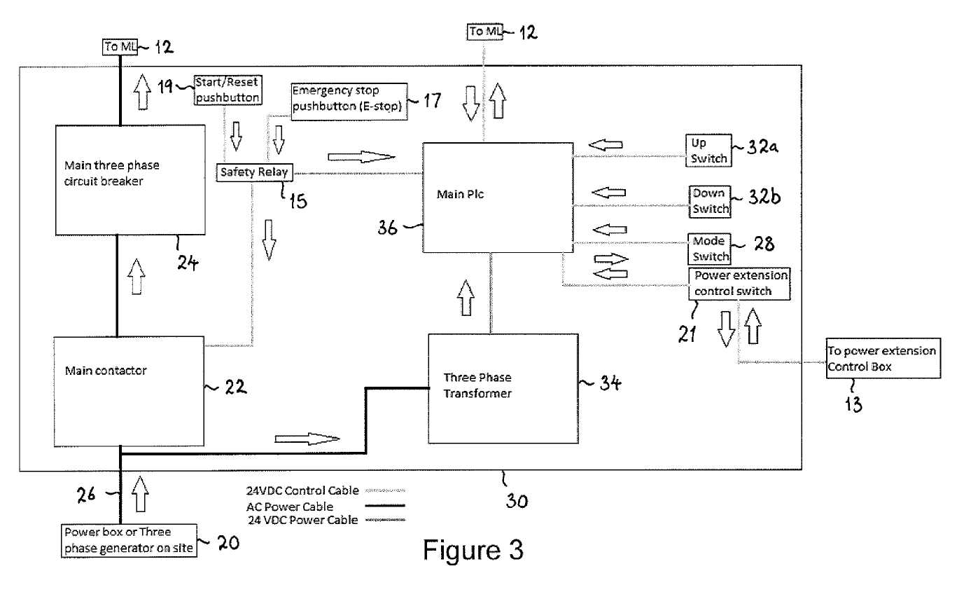

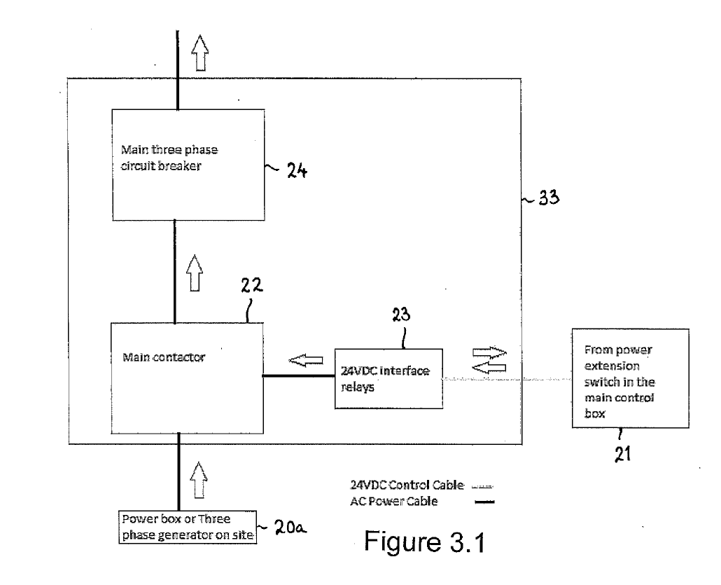

The control system comprises one or more power sources 20 for providing electrical power for a plurality of the modular lifting units 12 (see FIG. 2), and power cables 26 for delivering electrical power from the power source to each of the MLUs. A single main control box 10 may have a plurality of power cables 26 connected to it, each supplying power to a plurality of modular lifting units 12. One of more power extension control boxes 13 are optionally employed to distribute the electrical power to other MLUs via power cables 26 when several power sources are required to be used, as well as when the number of MLUs 12 in the operation exceed the maximum capacity of the main control box 10. In this embodiment the power source 20 comprises a plurality of 415 volt three phase generators or power boxes 20. The first three phase generator 20a is connected to a 415 volt three phase circuit breaker 24 and main contactor 22 in the main control box 10, (see FIG. 3 in which main control box 30 is similar to the main control box 10) which connects to the modular lifting units 12 via power cable 26. Each power extension control box (PECB) 13 is likewise provided with a 415 volt three phase circuit breaker 24 and main contactor 22 (see FIG. 3.1 in which PECB 33 is similar to the PECB 13). Each of the PECBs 13 is preferably under the control of the main control box 10.

The main control box 10 further comprises a mode switch 28 for switching between two modes: a group mode, in which the plurality of modular lifting units is controlled synchronously as a group, and an individual mode, in which any one of the modular lifting units is controlled independently of the other units. In group mode, synchronous movement of the modular lifting units is achieved by setting the VSD 14 in each unit, via the interface relay 18, to run the motor at the same speed with no speed feedback given to the main control box 10 from any part of the system other than control signals (limit switch signals and/or any other type of control signal from any other device) to stop the system in case the system reaches its maximum or minimum height.

Preferably the control box 10 further comprises two 24v DC switches 32a and 32b to switch the control system up and down respectively (see FIG. 3). In group mode all the modular lifting units 12 perform synchronised movement when the 24v DC switches are switched up or down. In individual mode, each individual modular lifting unit 12 can be controlled without affecting the other units. This allows calibration of each modular lifting unit to a specific but different starting point. Because each modular lifting unit 12 is carrying a different load (weight), a different current is required to make all motors run at the same speed. Thus the VSD 14 in each unit changes the amount of current drawn by each motor depending on the load.

The use of the VSDs 14 alone to set the speed and adjust current to the motors 16, in of each modular lifting units 12, solved the prior art problem caused by the high sensitivity of the encoders/synchronisation cards, which caused the VSD to switch the motor in the jack to on and off at very short intervals, while the VSD's and synchronisation cards hunted for a consistent position signal. However this synchronised control was of relatively low accuracy only suitable for building structures capable of withstanding deflection of more than 25 mm. For more accurate synchronised control of the plurality of modular lifting units, a second embodiment of the control system was developed.

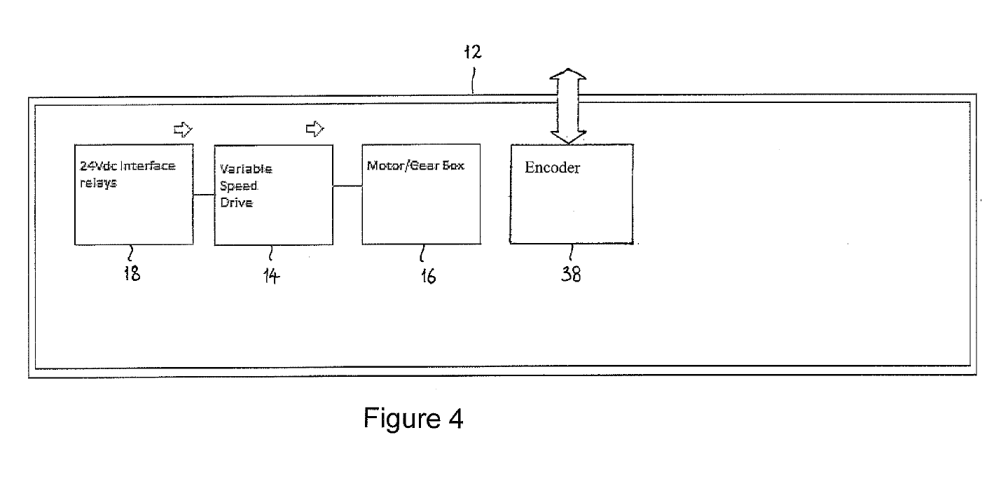

A second embodiment of the control system in accordance with the invention, for controlling a plurality of modular lifting units 12, is illustrated in FIGS. 3 and 4. The principal difference between the first and second embodiments of the control system is that the main control box 30 of the second embodiment is provided with a main controller 36, as shown in FIG. 3, and each modular lifting unit 12 is fitted with an encoder 38, as shown in FIG. 4. In other respects the control system of the second embodiment is substantially the same as the first embodiment, and therefore the same reference numerals will be used to refer to the similar parts and these will not be described again in detail.

The main control box 30 of this embodiment comprises a main controller in the form of a Programmable Logic Controller (PLC) 36 for controlling the supply of electrical power to each of the modular lifting units 12 in order to control the speed of the motors amongst other functions. A safety relay 15 provides a safety mechanism which will switch off the main contactor 22 when an emergency stop (E-stop) pushbutton 17 is pressed in case of an emergency. Pressing the E-stop pushbutton 17 will cause an immediate stop of the system. A Start/Reset pushbutton 19 will reset the safety relay 15 when the E-stop button has been released and the emergency situation had been resolved. Once this is done, the safety relay 15 will switch the main contactor 22 ON as well as sending a signal to the main PLC 36 to indicate the system is in a non-dangerous status. A three phase transformer 34 provides 24v DC power for the main PLC 36 and control system. Once the safety relay 15 indicates that the system is in a non-dangerous status, the main PLC 36 can command the modular lifting units to go up or down by using the 24 VDC control cable as well as controlling the power extension control box or boxes 13 if needed. A power extension control switch 21 is provided in the main control box 30 to control one or more power extension control boxes (PECBs) 33.

The PECB 33 of this embodiment, as illustrated in FIG. 3.1, further comprises a 24 VDC interface relay 23 which will turn the main contactor ON or OFF depending on a command from the main PLC 36 in the main control box 30. As mentioned before, the PECB or PECBs 33 will be used in order to distribute the electrical power when more than one power source is being used and/or when the number of modular lifting units 12 exceeds the maximum capacity that a control box can handle.

In order to overcome the prior art problems associated with using servo device in the modular lifting units, in this embodiment the main PLC 36 is employed to interpret the very high resolution feedback pulses from the encoder 38 and to subsequently control the motor speed via the VSD 14. A synchronisation card could only interpret the pulses but could not be configured to respond appropriately in controlling motor speed via the VSD. This was all due to the very high gearing and the high accuracy of the movement required.

Preferably the encoder 38 is positioned to be after the motor/gearbox 16 and is adapted to measure the actual actuator height (screw shaft of the jack) relative to a stationary point (jack base). This is a further difference with the prior art arrangement in which the encoder was mounted on the motor shaft (and fitted with a synchronisation card). In this embodiment the control system can accurately monitor the useful load position. The signals from the encoder 38 are received at a much slower rate than say from the shaft of a three phase motor running at 1410 RPM. The data processing functions performed by the main PLC 36, in order to interpret the feedback signals from the encoder 38 and determine the position of the modular lifting unit 12, is at a speed that will stop ‘motor hunting’.

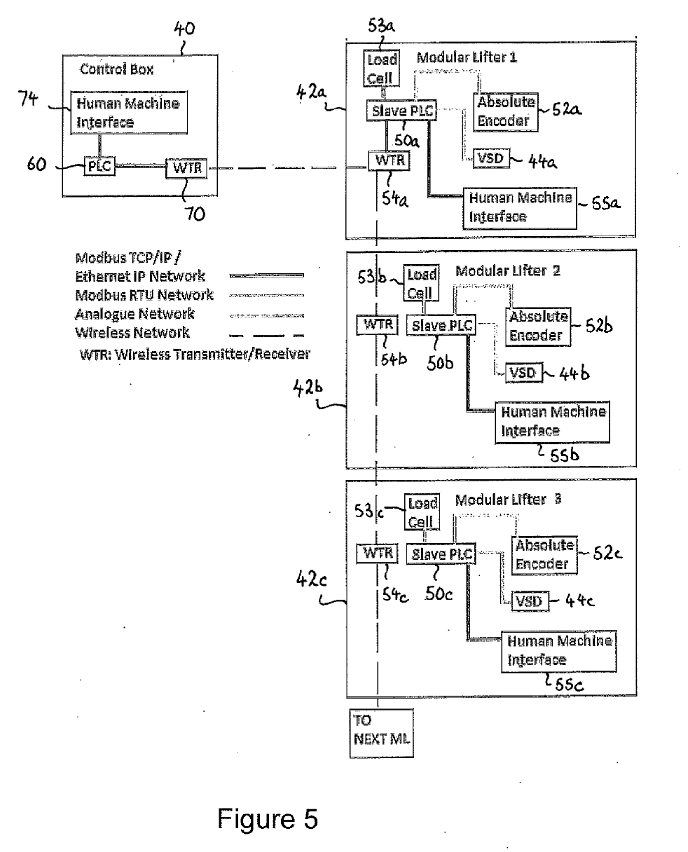

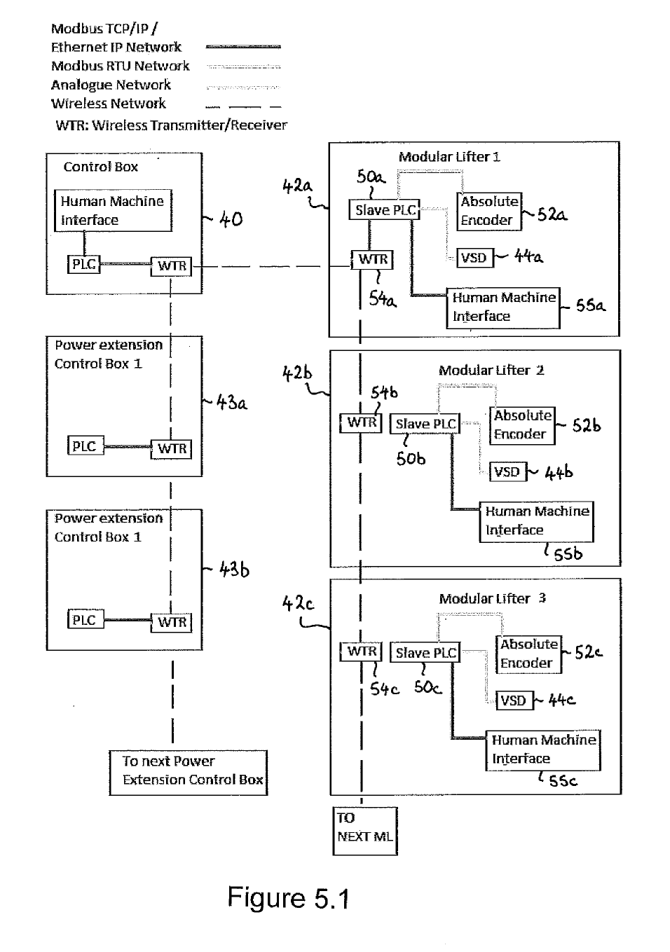

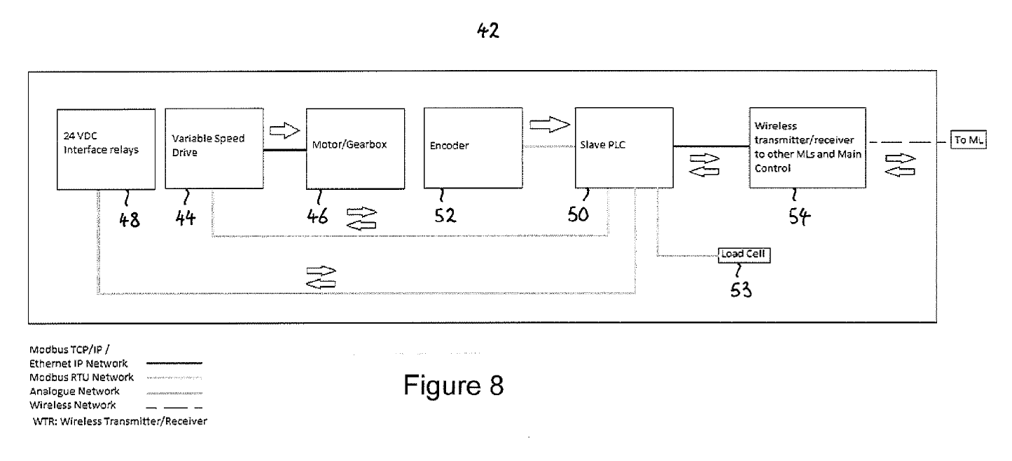

A third embodiment of a control system in accordance with the invention, for controlling a plurality of modular lifting units 42, is illustrated in FIGS. 5 to 8. As with the first and second embodiments, the control system comprises a main control box 40 for controlling a plurality of modular lifting units 42 connected in a daisy chain configuration, as shown in FIG. 5. Optionally, one or more power extension control boxes (PECBs) 43 are also provided to distribute the electrical power among additional MLUs 42, as shown in FIGS. 5.1 and 6. Each modular lifting unit (MLU) 42 comprises a variable speed drive (VSD) 44 for controlling the speed of an electric motor/gear box 46 in the MLU, as can be seen most clearly in FIG. 8. Each modular lifting unit 42 is also fitted with a 24 volt interface relay 48 and a MLU controller 50. In this embodiment the MLU controller is in the form of a Programmable Logic Controller (PLC) 50. The VSD 44 is used for controlling the ramp up/down set point speed of each modular lifting unit 42. This offers a constant draw of current that's accurately monitored through internal parameters.

Each modular lifting unit 42 is also supplied with an encoder 52 connected to an actuator, (after the motor/gearbox 46), where useful load position can be monitored. The encoder 52 generates a predetermined number of pulses, according to a prescribed resolution, for each 360° of rotation of the motor/gear box 46. Typically, the encoder 52 is used to measure the lift-carriage movement on a lifting jack, relative to a stationary reference point.

Preferably the encoder 52 is an absolute encoder. An absolute encoder is a position feedback device that reports absolute positional information. An absolute encoder generates a unique code for each position purchased via the number of pulses generated. When powered up, absolute encoders do not require a home cycle even if the shaft was rotated while the power was switched-off. The modular lifting units 42 are preferably portable lifting jacks that are needed to be powered off and on many times each week. Absolute encoders are the best product for this application. Typically the encoder 52 is fixed at the base of the MLU 42 (lifting jack), and one end of the encoder is fixed to the screw nut on the screw shaft of the lifting jack. The screw nut moves up the shaft, moving a lift carriage with it, when the shaft spins in the up direction. Alternatively the encoder 52 may be a magnetic tape encoder, linear encoder, tape draw encoder, wire draw encoder, Linear Variable Differential Transformer or any other device that allows the distance traveled by the MLU to be measured. Such devices can be of the incremental or absolute type, where the output can also be digital, analog or through a communication bus.

All the modular lifting units 42 (lifting jacks) will typically require a “zeroing” function to be performed pre-lift by a main PLC 60. The gear box ratio, along with other constant mechanical adders, ensures movement of the lift-carriages of each of the lifting jacks is around the same.

Typically the encoder 52 will allow a distance traveled by the lift-carriage to be measured with high resolution. The PLC 50 will compute this number and if needed alter the motor speed of the modular lifting unit 42 to address the issue of uneven weight distribution over the jack positions. Preferably each modular lifting unit 42 also includes a load cell 53 in order to measure the weight of the building structure to be lifted (see FIGS. 5 and 8). The load cell 53 will transmit the data to PLC 50 contained in each MLU 42, and the PLC will stop the operation when the load of the structure is higher than a rated lifting capacity that each modular lifting unit can carry.

The load cell 53 is also used to monitor changes to the load carried by the MLU 42. Such changes may occur if a MLU becomes “unhealthy” or “faulty”, or the load changes due to environmental factors such as wind, or a MLU is not maintaining its position compared to other MLUs. The load cell can be used to adjust the position of the MLU, if necessary, to keep the load constant.

Some possible scenarios to be analysed are:
the mechanical parts of the MLU wear and develop friction—this causes a higher level of current draw to keep the MLU elevating but the load remains the same. The PLC is programmed to report on the scenario by measuring speed, load, current draw and position and analysing this.
Where multiple surrounding MLUs experience a change in load sharing the programmed PLC reports on the scenario that confirms a change in the load stability between MLUs. The program checks MLU positions and if each MLU has maintained its position compared to other MLUs, a failure in the structure or MLU attachment is reported.
The load cell data is recorded and enables monitoring of hours, weight, total combined lifted weight and can be analysed to predict jack part maintenance intervals required to keep jacks healthy.

A wireless transmitter/receiver 54 provided in each modular lifting unit 42 enables wireless communication with other substations (modular lifting units 42), the power extension control boxes 43 and the main control box 40.

The PLC 50 in each modular lifting unit 42 will be used to:
Supply a Modbus RTU network for the VSD 44, analogue network encoder 52 and load cell 53.
Process the data received from the encoder 52 and VSD 44 against an algorithm (within the PLC) to amend the VSD speed or transmit data to a main PLC 60 via wireless communication.
Communicate wirelessly with other modular lifting units 42 to analyse their data and act accordingly for a successful lift.

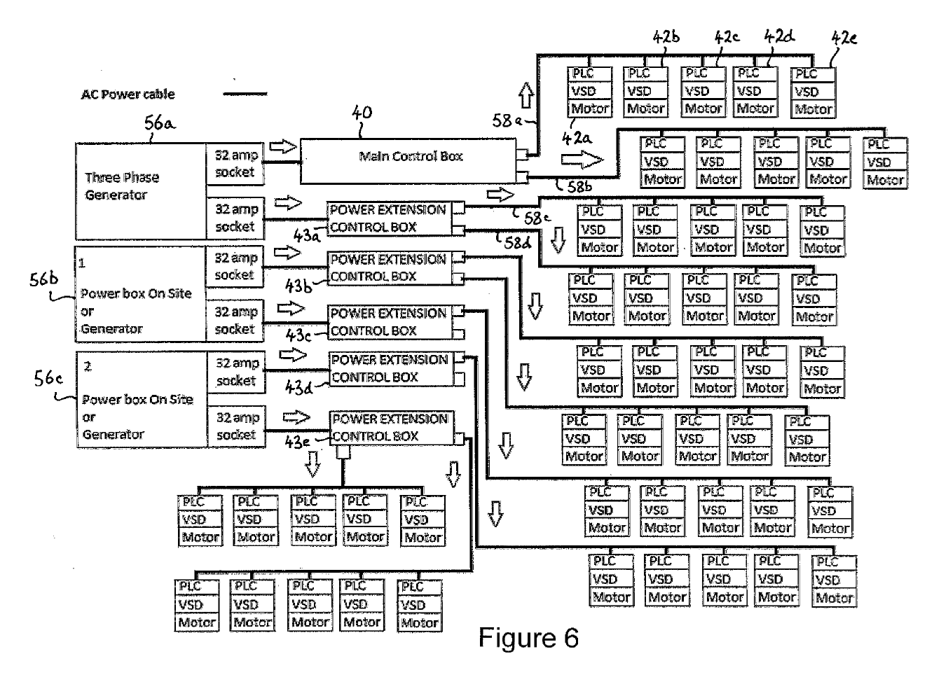

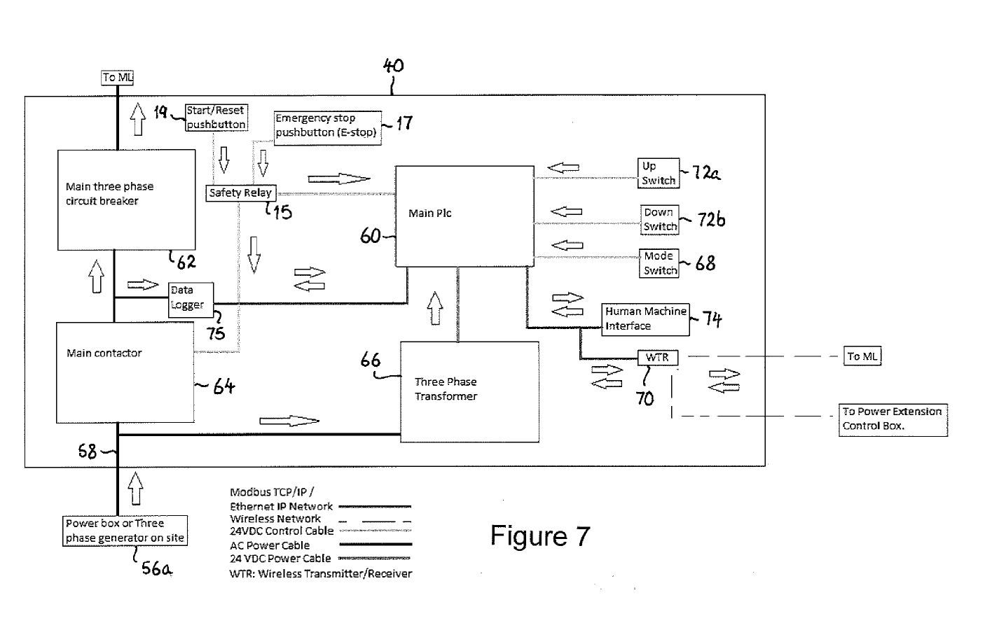

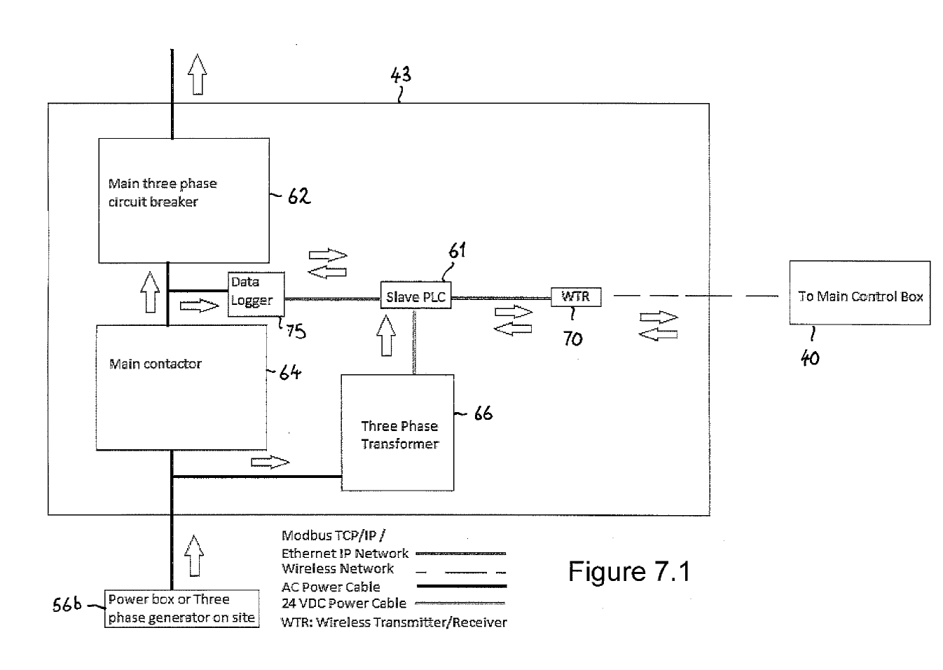

The control system further comprises one or several power sources 56 for providing electrical power for each of the modular lifting units 42, and power cables 58 for delivering electrical power from the main control box 40 and PECBs 43 to each of the modular lifting units 42, as shown in FIG. 6. In this embodiment the power source comprises a 415 volt three phase AC generator 56 or, if needed, several other power sources such as other generators and power boxes 56a and 56b. The three phase AC generator 56a is connected to a 415 volt three phase circuit breaker 62 and main contactor 64 in the main control box 40 (see FIG. 7). The main control box 40 activates the main contactor 64 which supplies the 415v three phase power to the motor in each modular lifting unit 42 via power cable 58. Main control box 40 also typically includes a power data logger 75 for monitoring and saving electrical parameters of a set of modular lifting units (MLUs).

The other generators and power boxes 56b and 56c are connected to a respective 415 volt three phase circuit breaker 62 and main contactor 64 in a respective power extension control box (PECB) 43 (see FIG. 7.1). The PECBs 43 are used when multiple additional modular lifting units are needed to be supplied by power and/or total current consumption of MLUs is more than the current capacity of main control box 40. Each power extension control box 43 also comprises a main contactor 64 and a slave Programmable Logic Controller (PLC) 61 to receive and transmit data to main control box 40. A power supply provides 24v DC power for the slave PLC 61 and control system. The PECBs 43 activate the main contactor 64 which supplies the 415v three phase power to the motor in each modular lifting unit 42 via power cables 58. PECBs 43 also typically include a power data logger 75 for monitoring and saving electrical parameters of a set of modular lifting units (MLUs) 42.

The control system (24Vdc) typically has a machine safety system through a global E-Stop pushbutton 17 (see FIG. 7) that is housed within the main control box 40 electrical enclosure. Provided the E-Stops are all in the correct position, 24Vdc can be activated through a start button 19, and the main contactor 64 which supplies the 415Vac three phase power to each motor in the modular lifting units 42.

The main control box 40 also comprises a main controller in the form of Programmable Logic Controller (PLC) 60 for controlling the supply of electrical power to each of the modular lifting units 42. A three phase transformer 66 provides 24v DC power for the main PLC 60 and control system. The control box 40 further comprises a mode switch 68 for switching the system between two modes: a group mode, in which the plurality of modular lifting units 42 is controlled synchronously as a group, and an individual mode, in which any one of the modular lifting units 42 is controlled independently of the other units. A wireless transmitter/receiver 70 preferably is provided in the main control box 40 for communicating wirelessly with each of the modular lifting units 42 and PECBs 43.

The main PLC 60 monitors the actual position of each modular lifting unit 42 and adjusts the speed by sending instructions to the VSDs 44 in each unit. This enables the control system to synchronise and control the actual position of each modular lifting unit (MLU) 42 via adjustments in speed. Control signals are received from, and transmitted to, each modular lifting unit 42 wirelessly, as shown in FIG. 5. The VSD 44 in each MLU 42 changes the amount of current drawn by each motor depending on the load. The VSD speed is set by the MLU controller (PLC) 50 on board each MLU 42. Each MLU controller 50 monitors the position of the MLU via its encoder 52. The MLU controller 50 controls the on board VSD 44 as a slave, as shown in FIG. 8. Each MLU controller (PLC) 50 in each MLU 42, in turn, acts as a slave to the Main controller (PLC) 60 in the main control box 40. This allows considerable more versatility in monitoring the maintenance, health of components, data log, position, load, response of each MLU 42. This combination of main controller 60 with multiple substation MLU controllers 50 enables the control system to effectively operate as a full SCADA (supervisory control and data acquisition) system.

Preferably the main control box 40 further comprises two 24v DC switches 72a and 72b to switch the control system up and down respectively. In group mode all the modular lifting units 42 perform synchronised movement when the 24v DC switches are switched up or down. In individual mode, each individual modular lifting unit 42 can be controlled without affecting the other units. This allows calibration of each modular lifting unit to a specific but different starting point.

Advantageously the main control box 40 is also provided with a Human Machine Interface (HMI) 74, for example a touch screen, to enable the PLC 60 to be programmed and reconfigured when required (see FIGS. 5 and 7). Preferably each of the modular lifting units 42 is also provided with a HMI 55.

The HMI touch screens enable a user to view meaningful control parameters of the various components of the control system (PLCs, VSDs, encoders, load cells). The user may tap the touch screen and dive deeper into adjusting a particular control parameter if needed, or resetting an internal error locally. Graphical buttons can be created to mimic a push button but the user has the option to create pages of buttons with a HMI touch screen.

The accuracy achieved when testing this embodiment of the control system was an error between a fully loaded and unloaded substation (MLU 42) of approximately 0.1 mm. In addition, one of the principal benefits of the present control system is the ability to control the lifting of a horizontal plane to a very high level of accuracy. Testing has confirmed an accuracy of ±0.6 mm between all MLUs.

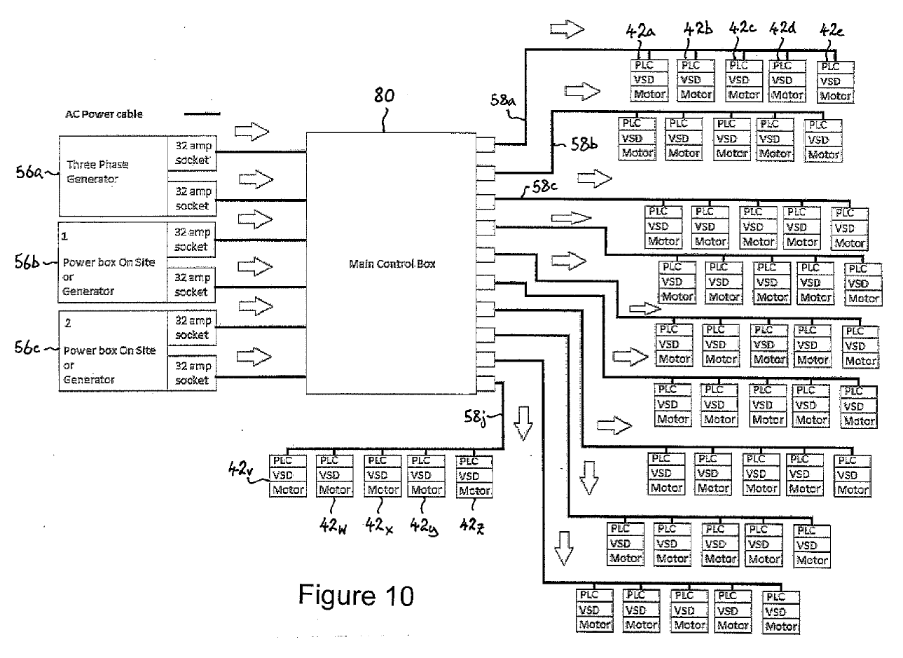

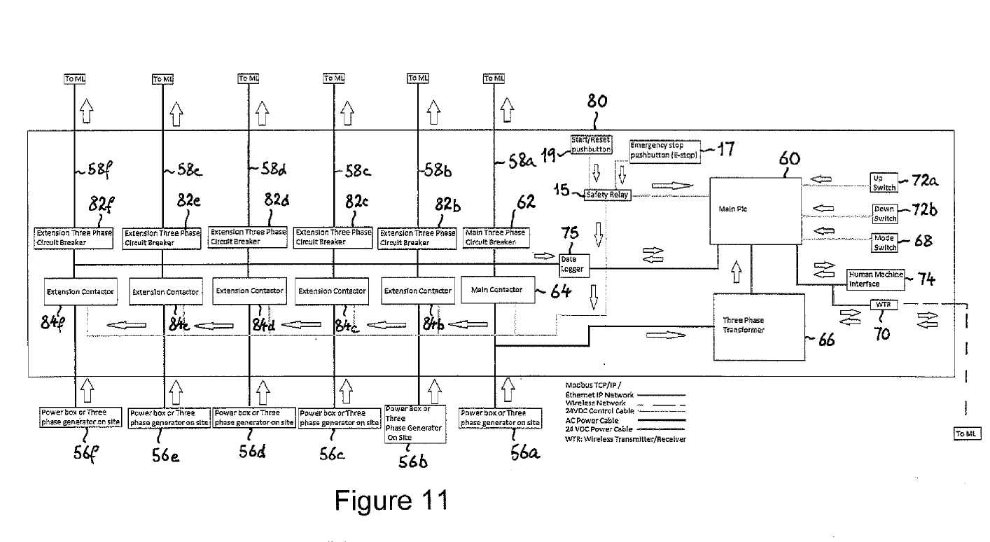

An alternative topology for the third embodiment of the control system in accordance with the invention, for controlling a plurality of modular lifting units 42, is illustrated in FIGS. 10 and 11. Similar parts in this alternative topology are given like reference numerals as in FIGS. 6 and 7 and will not be described again in detail. In this alternative topology the control system comprises a main control box 80 for controlling a plurality of modular lifting units 42 connected in daisy chain configurations, as shown in FIG. 10. A three phase AC generator 56a is connected to a 415 volt three phase circuit breaker 62 via a main contactor 64 in the main control box 80 (see FIG. 11). The main control box 80 activates the main contactor 64 which supplies the 415v three phase power to the motor in each modular lifting unit 42 via power cable 58a. Main control box 80 also typically includes a power data logger 75 for monitoring and saving electrical parameters of a set of modular lifting units (MLUs). The data logger 75 records various electrical parameters, such as total current drawn, voltage per operation, amount of electrical disconnections, three phase unbalance situations, amongst others, that are then sent to a main controller (PLC) 60 for future analysis.

In this alternative configuration, instead of one or more power extension control boxes (PECBs) to distribute the electrical power among the MLUs 42, the main control box is provided with a plurality of extension contactors 84 and extension 415v three phase circuit breakers 82. Instead of slave PLCs in each PECB, the main controller (PLC) 60 directly activates the extension contactors 84 which supply 415v three phase power from a plurality of additional on-site power boxes or three phase generators 56b, 56c, 56c, etc., to the motor in each of a plurality of modular lifting units (MLUs) 42 via power cables 58b, 58c, 58d, etc. The power data logger 75 is also connected to each of the extension contactors 84, and monitors and records the various electrical parameters of the additional MLUs 42.

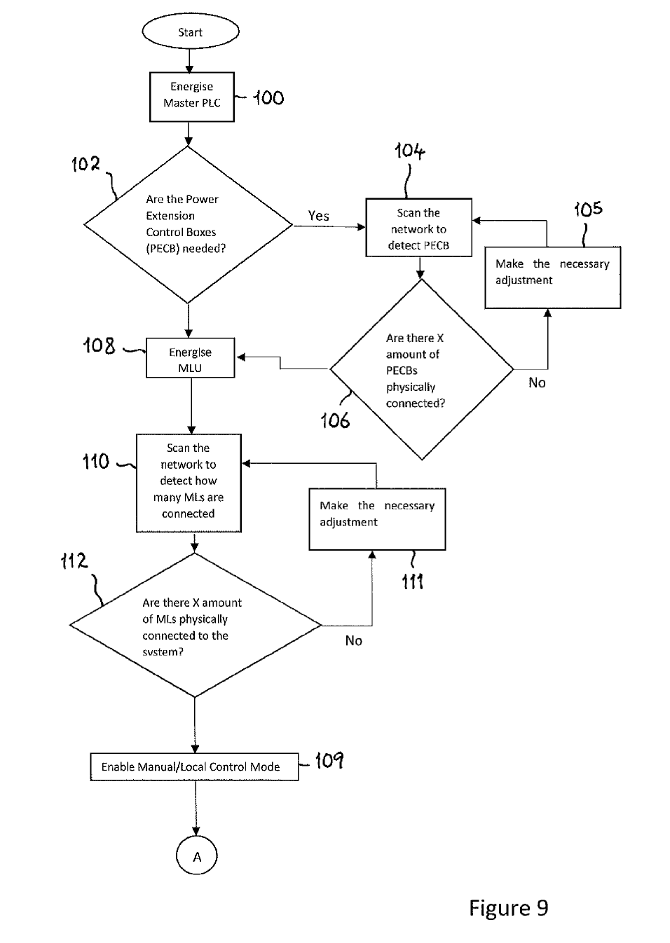

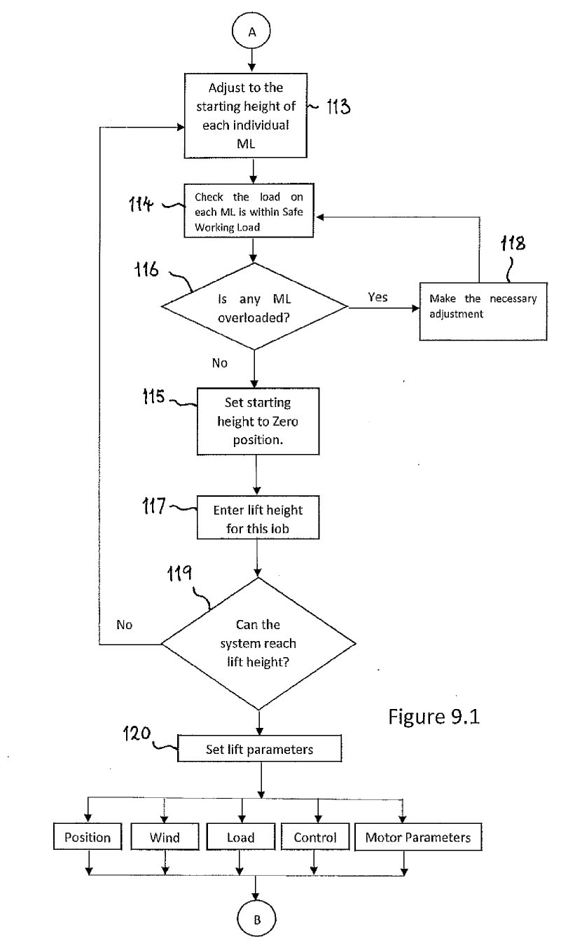

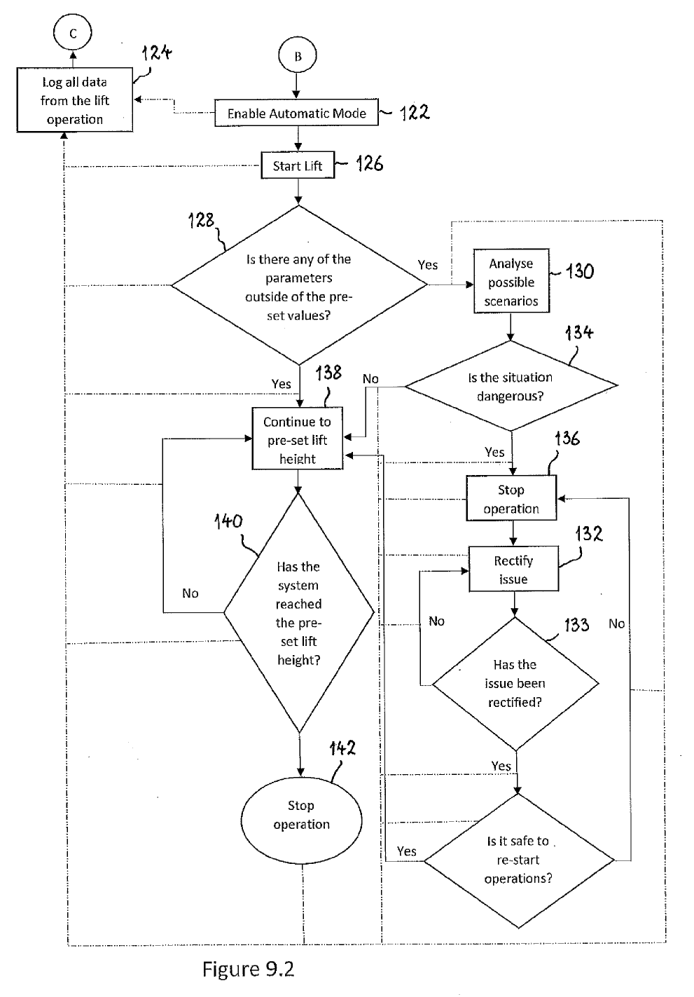

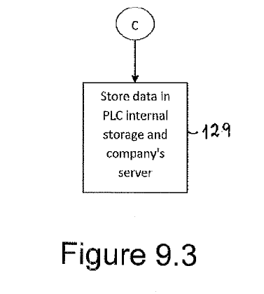

A method of controlling the operation of a plurality of modular lifting units, using the above control system, will now be described with reference to FIGS. 9 to 9.3. FIGS. 9 to 9.3 illustrate in flowchart form the method steps implemented by the software programmed into the main controller (PLC 30 or 60) in the second and third embodiments of the control system according to the present invention.

When the control system is switched ON the PLC 30 or 60 is energised at step 100 and then the system asks the operator if there are any power extension control boxes (PECBs) being used or needed for the current operation at step 102. If the answer is positive, the system switches on the contactor and starts scanning the network at step 104 to find how many PECBs are switched and connected. If X amount of PECBs are not yet connected, (X is a pre-set number depending on the application of the control system and MLUs), the necessary adjustment is made at step 105. Once it is detected at step 106 that X amount of PECBs are connected, the system energizes the MLUs at step 108. The system then commences scanning of the network (hardwired or wireless) at step 110 to detect how many, if any, modular lifting units (MLUs) 12 or 42 are connected to the network. If X amount of MLUs are not yet connected, (X is a pre-set number depending on the application of the control system and MLUs. Typically for lifting a building structure X=4 minimum), the necessary adjustment is made at step 111. When it is determined at step 112 that X number of MLUs are connected to the network, the operator enables the PLC to enter manual or local control mode at step 109. The operator will then proceed to the step of adjusting the starting height of each MLU 12 or 42 at step 113 (see FIG. 9.1). The PLC interrogates the load cells in each MLU to check, at step 114, that the load on that MLU is within the safe working load. If any one of the MLUs is overloaded, (determined at step 116), the PLC will suspend further operations until an adjustment is made (step 118) to reduce the load to be within the safe limit of that MLU. This may mean including an additional MLU into the lifting operation to distribute the load.

Provided that all MLUs are operating within their safe working load, and the starting heights have been adjusted (step 113), the starting position of the encoder in each MLU is set to a zero position at step 115, in order to ensure that all the MLUs start at the same base line height. Then the required lift height for this job is entered into the PLC by an operator, via the HMI touch screen, at step 117. At step 119, the PLC determines on the basis of the detected starting height of all the MLUs whether the system can reach the set lift height. If not, then the starting height of the MLUs may need to be re-adjusted at step 113. If there is no problem with the set lift height, the operator then sets the lift parameters at step 120. The lift parameters include such factors as the actual lift position of each MLU, the wind conditions, the load, the control mode and motor parameters.

Once all the lift parameters have been entered at step 120, the operator enables the PLC to execute automatic (group) mode at step 122 (see FIG. 9.2). At the same time, (step 124) the PLC commences a data logging operation, in which all data from the lift operation is automatically logged and stored by the PLC in its internal memory, at step 129 (see FIG. 9.3). This data may also be transmitted to the company's main server for back-up. It will be kept as a record of the lift operation and analysed for any anomalies or significant events during the lift.

In automatic group mode the PLC commences the lift operation at 126, and continues to monitor the operation of all components in the network. This includes receiving feedback signals from the encoder in each of the MLUs providing an indication of the actual lift position of the MLU. If it is detected at step 128 that any of the operating parameters is about to, or actually does, fall outside pre-set limits, the PLC analyses possible scenarios at step 130 that would explain the anomaly, and may attempt to rectify the issue at step 132. However, it also continually monitors the situation, and if it determines at step 134 that the situation is not safe, the lifting operation is paused at step 136.

At step 133 it checks if the potentially unsafe situation has been rectified, and only if it is safe to re-start operation (step 135) will it continue the lifting operation at step 138. On the other hand, if it is determined at step 134 that the situation is still safe, then the PLC continues the lifting operation to the pre-set lift height at step 138.

Once it detects at step 140 that the MLUs have reached the pre-set lift height, it will conclude the lifting operation at step 142.

In each of the described embodiments the modular lifting units (MLUs) have been lifting jacks powered by an electric motor, similar to that described in PCT/AU2014/000224. However it will be understood that the MLUs could be any suitable lifting device, and are not limited to the electrically-powered lifting jacks of the described embodiments. For example, the MLUs could also be hydraulically- or pneumatically-powered lifting jacks, in which case the power source for the MLUs would be a compressor.

Now that several embodiments of the control system have been described in detail, it will be apparent that the described embodiments provide a number of advantages over the prior art, including the following:
(i) Accurate and stable lifting of a building structure using a plurality of lifting jacks (modular lifting units).
(ii) Improved control during synchronised operation of the modular lifting units to ensure that the building structure is not subject to deflection during lifting.
(iii) Ability to control the lifting of a horizontal plane to a very high level of accuracy, e.g. an accuracy of ±0.6 mm between all MLUs.
(iv) More stable operation of the control system by using absolute or incremental encoders and on board controllers in the modular lifting units rather than servo devices.
(v) More versatile implementation due to use of wireless communication between the modular lifting units, and between the main control box and the modular lifting units.

It will be readily apparent to persons skilled in the relevant arts that various modifications and improvements may be made to the foregoing embodiments, in addition to those already described, without departing from the basic inventive concepts of the present invention. For example, other types of modular lifting unit could be employed, apart from the lifting jacks of the preferred embodiments. It will also be understood that other types of data processing device could be employed for the main controller and MLU controllers, apart from the Programmable Logic Controllers (PLCs) of the preferred embodiments. Therefore, it will be appreciated that the scope of the invention is not limited to the specific embodiments described.

1. A control system for controlling the operation of a plurality of modular lifting units, the control system comprising:
a plurality of modular lifting units;
a power source for providing power to each of the modular lifting units; and,
a main control box connected between the power source and the modular lifting units, the main control box comprising a mode switch for switching the system between two control modes: a group mode, in which the plurality of modular lifting units is controlled synchronously as a group; and, an individual mode, in which any one of the modular lifting units is controlled independently of the other units, and wherein, in group mode, synchronous movement of the modular lifting units is achieved by setting each unit to run at the same speed.

2. A control system for controlling the operation of a plurality of modular lifting units as defined in claim 1, wherein each modular lifting unit comprises a variable speed drive (VSD) for controlling the speed of an electric motor in the unit, and in group mode, synchronous movement of the modular lifting units is achieved by setting the VSD in each unit to run the motor at the same speed with no feedback from any part of the system.

3. A control system for controlling the operation of a plurality of modular lifting units as defined in claim 1, wherein the main control box further comprises:
a main controller, operatively coupled to the mode switch, for controlling the supply of electrical power to each of the modular lifting units;
a main contactor which connects the power source to the modular lifting units via a three phase circuit breaker; and,
a power data logger for monitoring and recording electrical parameters for each of the modular lifting units.

4-5. (canceled)

6. A control system for controlling the operation of a plurality of modular lifting units as defined in claim 1, wherein the main controller is a Programmable Logic Controller (PLC).

7. A control system for controlling the operation of a plurality of modular lifting units as defined in claim 1, wherein the control system further comprises a plurality of power extension control boxes (PECBs), when additional power sources are required and/or the number of modular lifting units exceeds a capacity of the main control box, each PECB being connected between an additional power source and a plurality of additional modular lifting units.

8. A control system for controlling the operation of a plurality of modular lifting units as defined in claim 7, wherein each of the PECBs is under the control of the main control box.

9. A control system for controlling the operation of a plurality of modular lifting units, the control system comprising:
a plurality of modular lifting units;
a power source for providing power to each of the modular lifting units;
a main control box connected between the power source and the modular lifting units, the main control box comprising:
a mode switch for switching the system between two control modes: a group mode, in which the plurality of modular lifting units is controlled synchronously as a group; and, an individual mode, in which any one of the modular lifting units is controlled independently of the other units; and,
a main controller operatively coupled to the mode switch for transmitting control signals to each of the modular lifting units, the main controller also receiving feedback signals from each of the modular lifting units wherein, in group mode, synchronous movement of the modular lifting units is achieved by the main controller using the feedback signals received from each of the modular lifting units to supply power to, monitor and control the speed of the modular lifting units.

10. A control system for controlling the operation of a plurality of modular lifting units as defined in claim 9, wherein each modular lifting unit (MLU) comprises an encoder for sensing a lifting position of the unit and providing a feedback signal to the main controller, wherein the encoder is connected to an actuator of the MLU, where a useful load position can be monitored, and wherein the encoder generates a predetermined number of pulses, according to a prescribed resolution, for each 360° of rotation of a motor/gear box in the MLU.

11-12. (canceled)

13. A control system for controlling the operation of a plurality of modular lifting units as defined in claim 10, wherein, the encoder is used to measure a lift-carriage movement on a lifting jack, relative to a stationary reference point.

14. A control system for controlling the operation of a plurality of modular lifting units as defined in claim 10, wherein the encoder is an absolute encoder or an incremental encoder.

15. A control system for controlling the operation of a plurality of modular lifting units as defined in claim 10, wherein each modular lifting unit further comprises a MLU controller for processing data received from the encoder and preparing the feedback signals, and wherein the MLU controller controls the operation of the modular lifting unit with reference to an algorithm within the MLU controller for controlling the MLU and/or transmitting the feedback signals to the main controller.

16. (canceled)

17. A control system for controlling the operation of a plurality of modular lifting units as defined in claim 9, wherein each modular lifting unit comprises a variable speed drive (VSD) for controlling the speed of an electric motor in the unit.

18-20. (canceled)

21. A control system for controlling the operation of a plurality of modular lifting units as defined in claim 9, wherein the control system further comprises a plurality of power extension control boxes (PECBs), when additional power sources are required and/or the number of modular lifting units exceeds a capacity of the main control box, each PECB being connected between an additional power source and a plurality of additional modular lifting units, wherein each PECB comprises a slave controller, operatively coupled to the main controller, for controlling the supply of electrical power to each of the additional modular lifting units, and wherein each PECB also includes a power data logger for monitoring and recording electrical parameters for the additional modular lifting units.

22-24. (canceled)

25. A control system for controlling the operation of a plurality of modular lifting units as defined in claim 15, wherein the main controller monitors the actual position of each modular lifting unit (MLU) and adjusts the lifting by sending instructions to the MLU controller in each MLU, and wherein the control system synchronises and controls the actual position of each modular lifting unit via adjustments in speed.

26. (canceled)

27. A control system for controlling the operation of a plurality of modular lifting units as defined in claim 9, wherein the main control box also comprises a wireless transmitter/receiver for transmitting and receiving wireless signals to/from the modular lifting units, each modular lifting unit also comprises a wireless transmitter/receiver for receiving control signals and transmitting feedback signals wirelessly to the main controller, and each PECB also comprises a wireless transmitter/receiver for transmitting and receiving wireless signals to/from the main control box and the additional modular lifting units.

28-29. (canceled)

30. A method of controlling the operation of a plurality of modular lifting units via a main control box and a plurality of power extension control boxes (PECBs), each PECB being connected to the main control box and between an additional power source and a plurality of additional modular lifting units (MLUs) respectively, the method comprising:
providing power to each of the MLUs either directly from the main control box or indirectly from a PECB;
detecting the number of PECBs; and
providing feedback signals from each of the PECBs to the main control box.

31. A method of controlling the operation of a plurality of modular lifting units as defined in claim 30, wherein the power extension control boxes (PECBs) are connected between various power sources, such as on-site generators or on-site power boxes or other power sources and the additional modular lifting units, wherein each PECB is controlled by the main control box, and wherein the main control box switches a main contactor inside each PECB ON or OFF in order to energize or de-energize the MLUs connected to each PECB respectively.

32-33. (canceled)

34. A method of controlling the operation of a plurality of modular lifting units as defined in claim 31, wherein each PECB sends a feedback signal or a series of feedback signals to the main control box to indicate if the main contactor in each PECB is working, and wherein each PECB includes a data logging device, which records various electrical parameters, such as total current drawn, voltage per operation, amount of electrical disconnections, three phase unbalance situations, amongst others, that are then sent to a main controller in the main control box for future analysis.

35. (canceled)

36. A method of controlling the operation of a plurality of modular lifting units via a main control box connected between a power source and the modular lifting units, the method comprising the steps of:
detecting the number of modular lifting units connected to a control network;
providing power to each of the modular lifting units in accordance with the method;
selecting one of two control modes: a group mode, in which the plurality of modular lifting units is controlled synchronously as a group; and, an individual mode, in which any one of the modular lifting units is controlled independently of the other units; and,
transmitting control signals from the main controller to the modular lifting units wherein, in group mode, synchronous movement of the modular lifting units is achieved by using feedback signals received from each of the modular lifting units to supply power to, monitor and control the speed of the modular lifting units.

37. A method of controlling the operation of a plurality of modular lifting units as defined in claim 36, wherein each modular lifting unit (MLU) comprises an encoder and the method comprises the further steps of: sensing a lifting position of the unit and providing a feedback signal to the main controller, and, wherein the encoder is an absolute encoder or incremental encoder.

38. (canceled)
